(19) United States
(12) Patent Application Publication
(10) Pub. No.: US 2025/0161134 A1
(43) Pub. Date: May 22, 2025

(54) FUNERAL COFFIN FOR CREMATION

(71) Applicant: Alberto RECCHIONI, Ancona (IT)

(72) Inventor: Alberto RECCHIONI, Ancona (IT)

(21) Appl. No.: 18/730,534

(22) PCT Filed: Jan. 13, 2023
(86) PCT No.: PCT/IB2023/050311

§ 371 Date: Jul. 19, 2024

(30) Foreign Application Priority Data
Jan. 20, 2022 (IT) 102022000000911

(51) Int. Cl. A61G 17/007; A61G 17/04

(52) U.S. Cl. CPC A61G 17/007; A61G 17/04

(57) ABSTRACT

The funeral coffin (1) for cremation comprises a plurality of boundary walls (2) made of a biopolymer material comprising: —one bottom wall (3); —a plurality of perimeter walls (4) defining, with the bottom wall (3), one internal volume (5) for the containment of one corpse; —one lid (6) intended to close the internal volume (5) at the top; wherein the biopolymer material is of a non-biodegradable type.

### TECHNICAL FIELD

The present invention relates to a funeral coffin for cremation.

### BACKGROUND ART

As is well known, a funeral coffin is a container, typically made of solid wood, designed for the storage, transportation and burial of a corpse placed inside.

Specifically, a funeral coffin is traditionally provided with a bottom wall and with a plurality of perimeter walls which define an internal volume, enclosed by a lid, within which to lay the corpse.

It should be specified that the sizing of funeral coffins is strongly related to the physical characteristics of the corpse they are intended to contain, such as e.g. height and body size.

Specifically, the internal volume should be large to match the size of the corpse to be laid to rest.

This leads, as an inevitable consequence, to the fact that traditional funeral coffins are provided with rather large overall dimensions that result, therefore, in substantial transportation and storage costs.

This fact is particularly inconvenient considering that, as long as the corpse is not placed in the funeral coffin, the large internal volume results in unnecessary complications in the movement of the funeral coffin itself.

What's more, the use of solid wood gives funeral coffins a particularly heavy weight that results in even more complex transportation and storage of the same.

In this regard, it is worth mentioning that the precise choice of this material also results in major environmental issues, among which it is good to include the felling of a large number of trees (consider that in Europe alone more than 700,000 large trees are felled each year).

This, in addition to causing the deforestation of many hectares of forests and woodlands, is also known to be linked to a reduction in the absorption capacity of carbon dioxide produced by human activities.

Added to this, the burning of the funeral coffin for the cremation of the corpse results in the release of all the carbon dioxide absorbed in life by the wood as well as numerous pollutants into the atmosphere, exacerbating even more the negative environmental consequences caused by such known coffins.

What's more, wood machining results in a large amount of waste that obviously requires appropriate disposal treatments and ultimately causes the production of additional carbon dioxide.

To solve, at least partly, the aforementioned problems, the use of funeral coffins constructed in accordance with the teachings of the ITAN20120062 patent is known.

This document illustrates, in particular, a funeral coffin made in its parts from biodegradable biopolymers partly derived from plant and/or animal biomass.

The peculiar physical characteristics of these materials make it possible, in fact, to create a lightweight, waterproof, airtight as well as aesthetically valuable funeral coffin to give decorum and dignify the corpse contained therein.

Despite this, the funeral coffin illustrated in the aforementioned patent appears amenable to numerous refinements.

In fact, making a funeral coffin from biodegradable biopolymer materials turns out to be a particularly inconvenient choice since it still results in significant production of polluting compounds and greenhouse gases (e.g., carbon dioxide, carbon monoxide, hydrocarbons, nitrogen oxides) in the case of cremation.

In other words, the funeral coffin described in patent document ITAN20120062 does not allow effectively mitigating the many environmental issues outlined above, thus resulting in significant ecological damage as a result of its combustion.

Not only that, but the patent document ITAN20120062 teaches how to carry out the assembly of the perimeter walls and of the bottom wall using permanent fastening elements of the type of glues, dowels and/or screws.

This fact, however, proves to be particularly inconvenient, as it makes it necessary to rely on specialized personnel who, in addition to running risks of injury in the assembly of the funeral coffin, results in an inconvenient increase in the construction expense of the latter and, therefore, in the final purchase price of the assembled product.

Finally, it is worth noting that the patent document ITAN20120062 illustrates a funeral coffin provided, for the most part, with the same overall dimensions as traditional wooden funeral coffins and, therefore, does not allow for the resolution of the related problems already mentioned.

### DESCRIPTION OF THE INVENTION

The main aim of the present invention is to devise a funeral coffin for cremation with a low environmental impact, that is, one that allows the release of less carbon dioxide and pollutants than the funeral coffins of known type.

Within this main aim, the object of the present invention is to devise a funeral coffin for cremation with low weight and simple and intuitive assembly.

Another object of the present invention is to devise a funeral coffin for cremation that can overcome the aforementioned drawbacks of the prior art within the framework of a simple, rational, easy and effective to use as well as affordable solution.

The aforementioned objects are achieved by this funeral coffin for cremation having the characteristics of claim 1.

### BRIEF DESCRIPTION OF THE DRAWINGS

Other characteristics and advantages of the present invention will become more apparent from the description of a preferred, but not exclusive, embodiment of a funeral coffin for cremation, illustrated by way of an indicative, yet non-limiting example, in the attached tables of drawings in which:

FIG. 1 is an overall, axonometric view of the coffin according to the invention;

FIGS. 2 through 4 are detailed axonometric views of parts of the coffin according to the invention;

FIG. 5 graphically compares the amount of carbon dioxide generated with the production of the funeral coffin according to the invention and the amount generated with the production of a traditional funeral coffin made from fossil polymer;

FIG. 6 graphically compares the amount of carbon dioxide generated with the combustion of a funeral coffin according to the invention and the amount generated with the combustion of a traditional wooden funeral coffin;

FIG. 7 graphically compares the consumption by weight and volume of methane for the combustion of the funeral coffin according to the invention and of a traditional wooden funeral coffin;

FIG. 8 graphically compares the amount of carbon dioxide generated with the production of the funeral coffin according to the invention and the amount generated with the production of a traditional funeral coffin made from biodegradable biopolymer.

### EMBODIMENTS OF THE INVENTION

With particular reference to these figures, reference numeral 1 globally indicates a funeral coffin for cremation.

The funeral coffin 1 for cremation comprises a plurality of boundary walls 2.

Advantageously, at least one of the boundary walls 2 is made at least partly hollow.

Preferably, each of the boundary walls 2 is made at least partly hollow.

This makes it possible to drastically reduce the overall weight of the coffin 1 and thus to simplify greatly the movement thereof.

Specifically, the boundary walls 2 comprise:
at least one bottom wall 3;
a plurality of perimeter walls 4 defining, with the bottom wall 3, at least one internal volume 5 for the containment of at least one corpse;
at least one lid 6 intended to close the internal volume 5 at the top.

The bottom wall 3 is a substantially prismatic member intended to physically support the corpse deposited in the internal volume 5.

Specifically, the bottom wall 3 has an overall height of between 1.5 cm and 5.5 cm, better still of between 2.5 cm and 4.5 cm, preferably equal to 3.5 cm.

To carry out its function efficiently, the bottom wall 3 comprises at least one upper surface 7 facing, in use, the internal volume 5 on which the corpse is laid.

The upper surface 7 is substantially flat and is sized with an area corresponding to that of the corpse to be laid in the internal volume 5.

In this regard, it is specified that the use of the term “corresponding” refers to the fact that the upper surface 7 must be sized depending on the precise dimensions of the corpse lying therein.

In particular, the upper surface 7 must be wide enough to allow the bottom wall 3 to physically support the corpse along its entire length.

In addition, the bottom wall 3 comprises a collecting structure 8 for the fluids produced by the decomposition of the corpse.

Specifically, the collecting structure 8 comprises a plurality of cross-pieces 8a arranged incidentally with respect to each other and defining a plurality of hollow compartments 8b adapted to be filled by the decomposition fluids.

In actual facts, the cross-pieces 8a are arranged to collectively define a grid.

In other words, the special geometry with which the cross-pieces 8a are arranged determines that gaps are defined between them, bounded peripherally by the cross-pieces themselves, which coincide with the compartments 8b.

In the present case, the compartments 8a are provided with at least one through cavity that is cut out at the base of the cross-pieces 8a and is passable by the decomposition fluids.

This technical expedient makes it possible to equalize the average level of the decomposition fluids within the coffin 1.

In fact, the presence of through cavities allows the decomposition fluids to displace, by the principle of communicating vessels, between one compartment 8b and the other, ultimately resulting in a more homogeneous overall distribution.

Not only that, but the special expedient of providing cross-pieces 8a arranged incidentally with each other lends considerable stiffness and structural strength to the coffin 1, allowing it to be transported and handled more safely.

Preferably, the cross-pieces 8a have a height of between 0.5 cm and 4.5 cm, better still of between 1.5 cm and 3.5 cm, preferably equal to 2.5 cm.

This value makes it possible to obtain a collecting structure 8 able to collect a large amount of decomposition fluids, e.g., up to 28 liters, efficiently carrying out their function regardless of the physical characteristics of the corpse contained in the internal volume 5.

Turning to a description of the perimeter walls 4, it should first be said that these are members with a substantially prismatic conformation having two faces (one facing, in use, the internal volume 5 and the other facing, in use, outwardly with respect to the internal volume 5) and a shim located between the two faces.

In this sense, each of the perimeter walls 4 comprises:
at least one lower base 9 arranged, in use, resting on the bottom wall 3;
at least one upper base 10 opposite the lower base 9;
at least one lateral edge 11 arranged transversely with respect to the bottom wall 3 to define, in use, the depth of the internal volume 5;
at least one internal face 12 facing, in use, the internal volume 5; and
at least one external face 13 facing, in use, externally with respect to the internal volume 5.

Each of the perimeter walls 4 comprises a lower base 9, an upper base 10, two lateral edges 11, an internal face 12 and an external face 13.

In detail, the lateral edges 11 are arranged perpendicularly to the lower base 9 and to the upper base 10 and the latter are arranged parallel to each other.

In this case, the lateral edges 11 are located between the lower base 9 and the upper base 10 and define, with the latter, the perimeter of the internal face 12 and of the external face 13.

In accordance with a preferred embodiment, the coffin 1 comprises four perimeter walls 4.

According to this embodiment, moreover, the perimeter walls 4 have a substantially prismatic conformation with a rectangular base.

In this case, the coffin 1 has a so-called “parallel”/“American-style” shape.

In actual facts, this means that the lower base 9, the upper base 10, the lateral edges 11, the internal face 12 and the external face 13 are rectangular in shape.

Different conformations of the perimeter walls 4 cannot however be ruled out.

By way of example, one or more perimeter walls 4 having substantially prismatic conformation with a hexagonal base, or substantially prismatic with a pentagonal base, or having other geometric shapes still, regular or irregular, known to the expert in the field, cannot be ruled out.

For example, by employing two prism-shaped perimeter walls 4 having a hexagonal base and two other prism-shaped perimeter walls 4 having a rectangular base, it is possible to obtain a coffin 1 having a so-called “shoulder”/“hexagonal” shape.

A coffin 1 cannot also be ruled out provided with a different number of perimeter walls 4, such as e.g. six.

In the latter case, a coffin 1 having a so-called “shoulder”/“hexagonal” shape can be obtained by employing all six prism-shaped perimeter walls 4 having a rectangular base and arranged to form a substantially hexagonal structure.

As for the lid 6, the latter is a substantially prismatic member with an elongated conformation.

The lid 6 can conveniently be flat (particularly in the case of a coffin 1 made with a “parallel”/“American-style” shape) or curved (particularly in the case of a coffin 1 made with a “shoulder”/“hexagonal” shape).

In this case, the lid 6 comprises:
at least one lower portion 14 facing, in use, towards the internal volume 5 and arranged resting on each of the upper bases 10; and
at least one upper portion 15, opposite the lower portion 14 and facing, in use, outwardly with respect to the internal volume 5.

This means that only the upper portion 15 of the lid 6 and the external faces 13 of the perimeter walls 4 are visible from the outside.

Having introduced the various boundary walls 2, it is necessary at this point to specify that they are made at least partly from a biopolymer material.

In this regard, in the context of this disclosure, the term “biopolymer” is intended to refer to a wide range of recyclable materials derived from renewable raw materials (e.g., polysaccharides and/or proteins) and/or from waste materials.

The low density of such materials advantageously allows for making a particularly lightweight and easily transportable coffin 1, which enables operators to carry out funeral operations easily and safely.

According to the invention, the biopolymer material is of the non-biodegradable type.

Preferably, the non-biodegradable biopolymer material is selected from the list comprising: bio-polyethylene (bio-PE), bio-polyethylene furanoate (bio-PEF), bio-polyestradiol phosphate (bio-PEP), bio-polyethylene terephthalate (bio-PET), bio-polypropylene (bio-PP).

It is emphasized that the special expedient of making the boundary walls 2 from non-biodegradable biopolymer materials allows drastically reducing the production of pollutant compounds and greenhouse gases (e.g., carbon dioxide, carbon monoxide, hydrocarbons, nitrogen oxides, hydrochloric acid, dioxins, furans, formaldehyde and heavy metals) during the cremation of the coffin 1.

In other words, the use of such materials turns out to be particularly advantageous from the point of view of the environmental impact as it allows for a significant reduction in the carbon footprint (which is known to represent the amount of greenhouse gases emitted during all phases of the process) due to the cremation of the coffin 1 compared to the use of fossil-derived polymers, wood and biodegradable biopolymers.

To explore this in more detail, the amount of carbon dioxide released from the production and subsequent combustion of the coffin 1 and of the traditional funeral coffins is compared below.

By comparing, first of all, non-biodegradable biopolymers to fossil-derived polymers, it is good to highlight that the production of 24 kilograms of bio-polyethylene, which is required for the construction of the coffin 1, results in the absorption of 74.16 kilograms of carbon dioxide from the environment.

This is due to the fact that bio-polyethylene has a negative carbon footprint and, specifically, equal to −3.09; this means that the production of one kilogram of this material not only does not result in the emission of carbon dioxide, but rather results in the absorption of 3.09 kilograms of this substance from the environment.

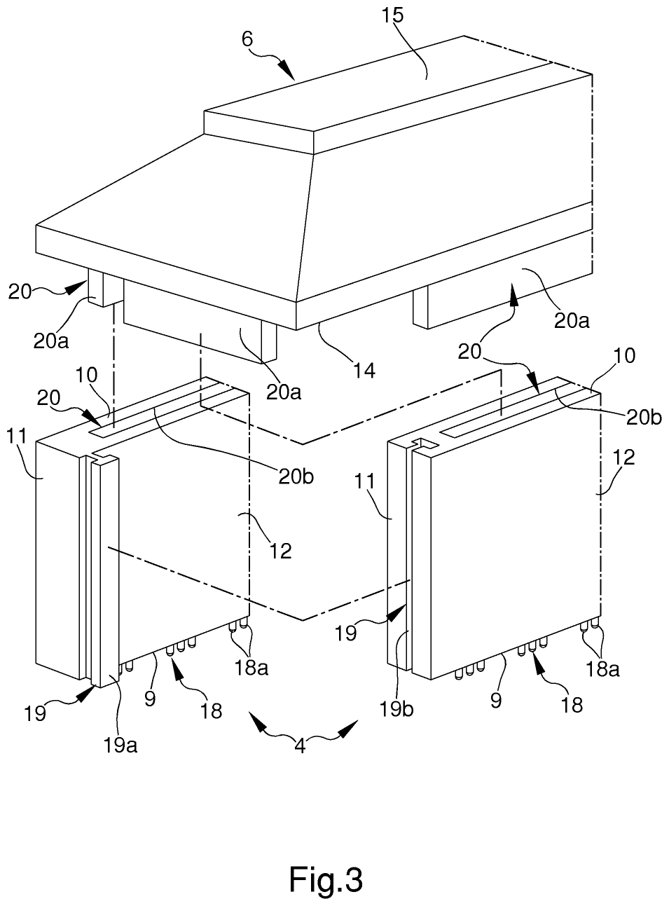

In contrast, the production of a similar amount of fossil-derived polyethylene for the production of a traditional funeral coffin results in the release of as much as 44 kg of carbon dioxide into the atmosphere (see graph in FIG. 5).

It is therefore easy to appreciate that the use of non-biodegradable biopolymers for the production of the coffin 1 allows for a drastic reduction in the amount of carbon dioxide generated with respect to the use of fossil-derived polymers, thus resulting in a distinct environmental benefit.

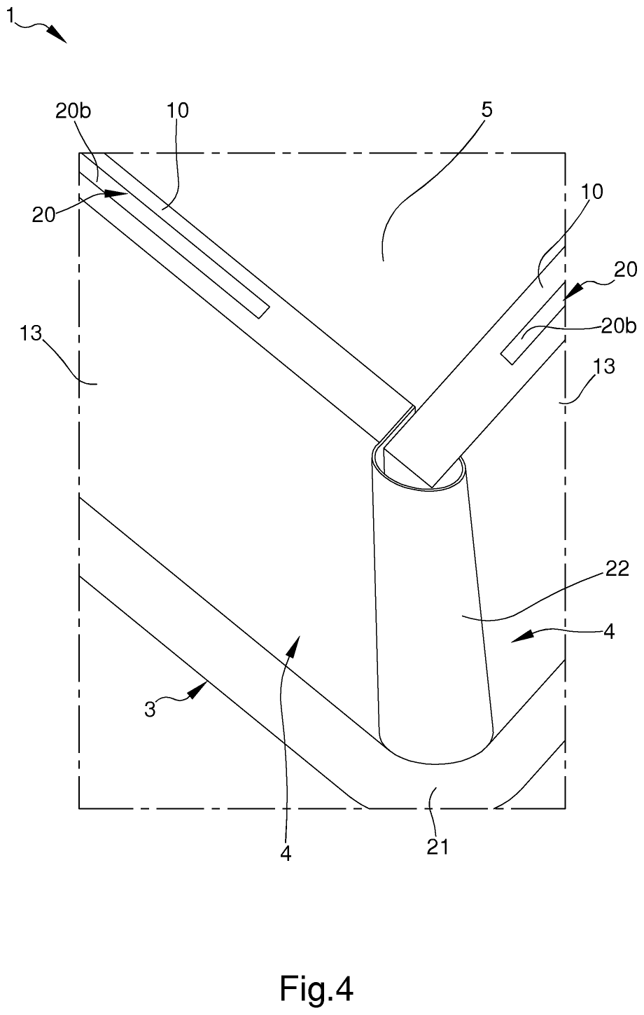

Similar considerations are also obtained from the comparison, shown in FIG. 6, between the coffin 1 and the traditional funeral coffins made from wood.

In fact, the combustion of each wooden coffin (average weight of about 70 kg) produces 128 kg of carbon dioxide, to which must be added the 26.5 kg of carbon dioxide produced by methane for a total of 154.5 kg of carbon dioxide.

In addition to these, it is also necessary to take into consideration the numerous pollutants derived, e.g., from the combustion of glues used in the construction of such traditional coffins.

In contrast, the coffin 1 made from bio-polyethylene (average weight of about 24 kg) produces 75.68 kg of carbon dioxide when burned; however, given the negative carbon footprint of this material, the entire life cycle of the coffin 1 results in the release of only 4.3 kg of carbon dioxide into the atmosphere (a calculation made following the indications of LCA, “life cycle assessment”).

One should, then, reflect on the fact that the cremation process is, as is well known, particularly energy-intensive; the temperature of the furnace, in fact, must be maintained between 850° C. and 1100° C. for an average time, which, in the case of traditional coffins, is about 70 minutes, 30 of which are just necessary for the combustion of the coffin itself.

In this regard, the coffin 1 made by means of non-biodegradable biopolymers takes about 4 minutes to be burned, a saving of as much as 26 minutes compared to wooden coffins; it is easy to appreciate how this fact, inducing an overall reduction in cremation process time by about 37%, leads to a marked and substantial improvement in the efficiency of the combustion process.

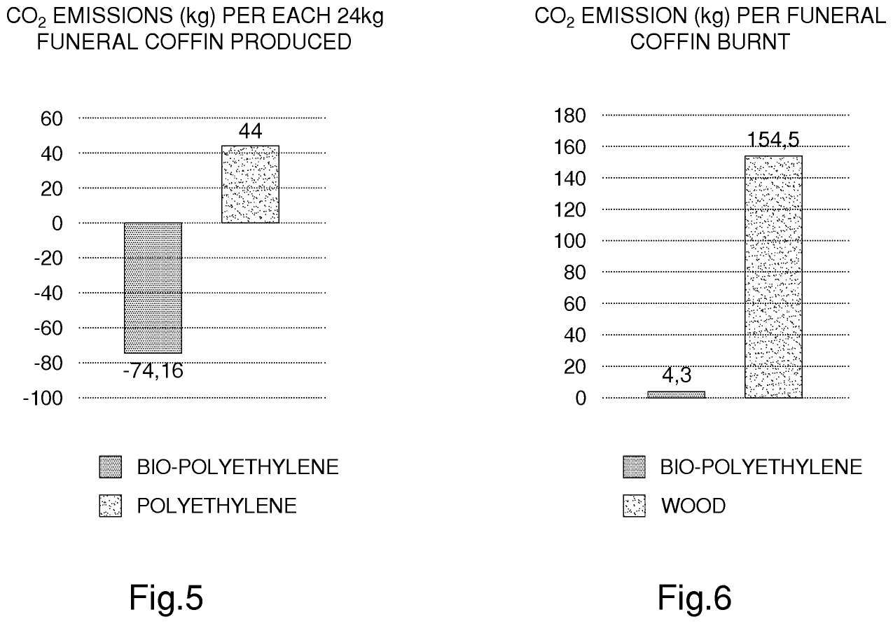

As shown in the graph in FIG. 7, this fact also results in a large reduction in methane gas consumption, from 11.14 kg (corresponding to 16.6 m³) for the combustion of wooden coffins to just 1.48 kg (corresponding to 2.2 m³) for the combustion of the coffin 1 (87% reduction by weight).

It should also be considered that some non-biodegradable biopolymers such as, e.g., bio-polypropylene, have a particularly high calorific value and, therefore, develop a lot of heat during their combustion.

This property, therefore, allows the furnace temperature required to burn the coffin 1 to be reduced, resulting in significant and important energy savings.

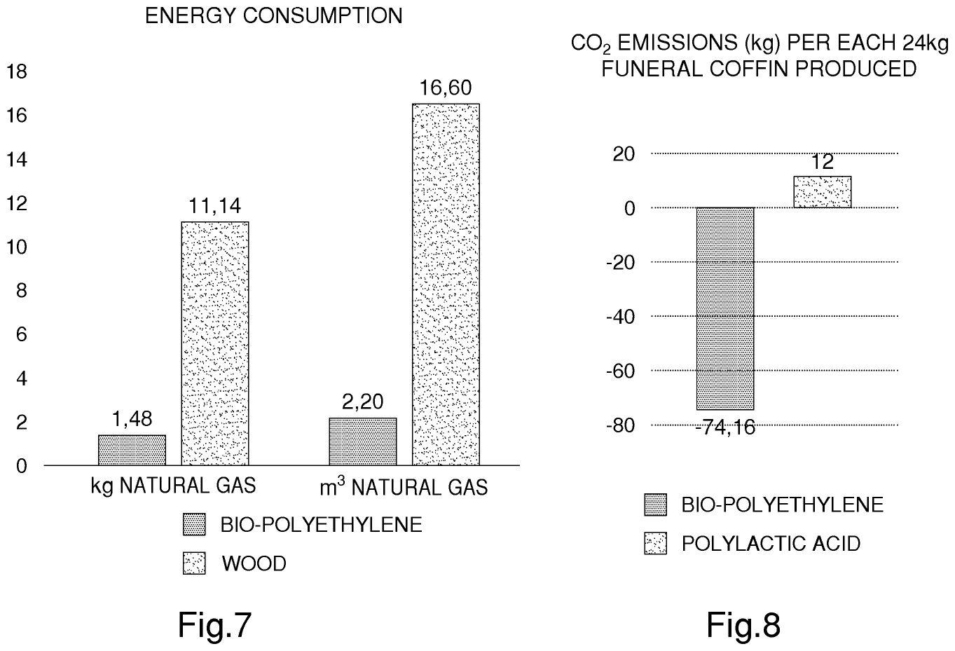

Finally, by comparing non-biodegradable biopolymers with biodegradable biopolymers (FIG. 8) it is evident to appreciate that, again, the use of the former is significantly convenient than the latter from an ecological point of view.

In this regard, in fact, it is worth considering that the absolutely most widely used biodegradable biopolymer, namely polylactic acid (PLA), has a positive carbon footprint equal to 0.5, thus far from the values just described regarding bio-polyethylene.

This means that, as visible in FIG. 8, the production of a funeral coffin made from PLA results in the emission of 12 kg of carbon dioxide, while the production of the coffin 1 made from bio-PE results in the absorption of 74.16 kg of carbon dioxide.

In addition to the environmental benefits, it is also worth mentioning that the chemical-physical 1 structure of the biodegradable biopolymers makes manufactured articles made from such materials particularly fragile, and therefore sensitive to shocks, at temperatures below 55° C.

By virtue of this, it is straightforward to appreciate that the biodegradable biopolymers prove to be totally unsuitable for the manufacture of large manufactured articles such as funeral coffins, which are known to require considerable strength and structural resistance.

In this regard, processes are known wherein the biodegradable biopolymers are added with special compounds such as wood dust or hemp (bio-composites) in order to improve their chemical-physical and/or mechanical properties.

This practice, however, is not only unsuitable for giving biodegradable biopolymers structural properties similar to those of non-biodegradable biopolymers, but also results in a large increase in the carbon footprint and, therefore, in the amount of carbon dioxide produced with the cremation of the coffin.

What's more, it should also be kept in mind that the most commonly used biodegradable biopolymers tend to crystallize during molding, thus becoming heat-resistant and thus slowing down the production cycle.

This means that, in addition to having the drawbacks outlined above, the use of biopolymers also results in a severe penalty in business productivity and the quality of the coffins produced.

Ultimately, it is clear to appreciate that the use of non-biodegradable biopolymers proves to be quite advantageous in comparison to wood as much as to fossil-derived polymers as much as to biodegradable biopolymers, thus enabling the drawbacks of the prior art previously complained of to be effectively remedied.

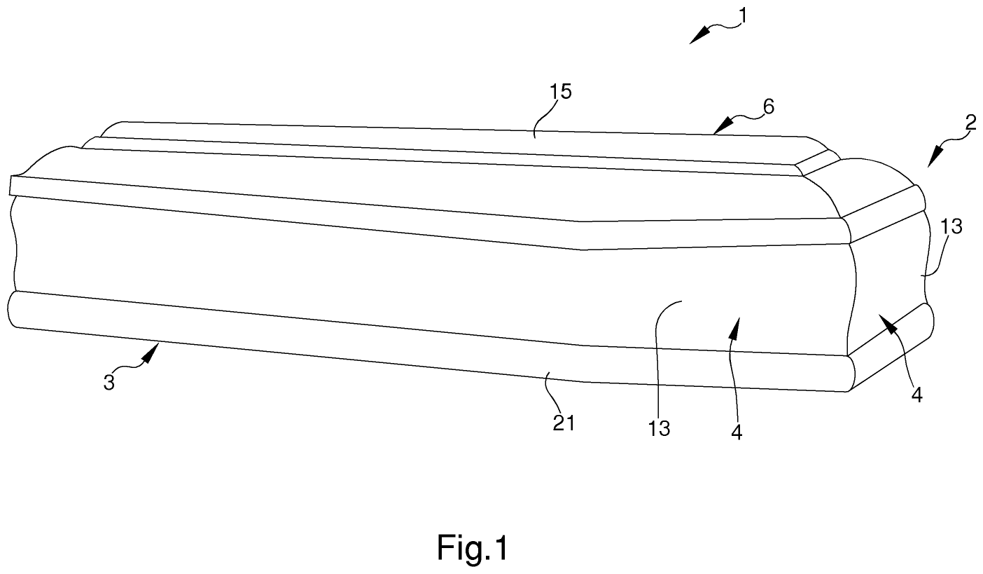

According to a first embodiment shown in FIG. 1, the coffin 1 is made as a single monolithic body.

In other words, in this first embodiment, the boundary walls 2 are rigidly connected to each other.

This implies, therefore, that the coffin 1 can be conveniently produced through a single technological process.

For example, the coffin 1 can be made through a single injection molding process.

In this way, that is, by making the coffin 1 in a single technological process, it is clearly possible to cut production time and cost down.

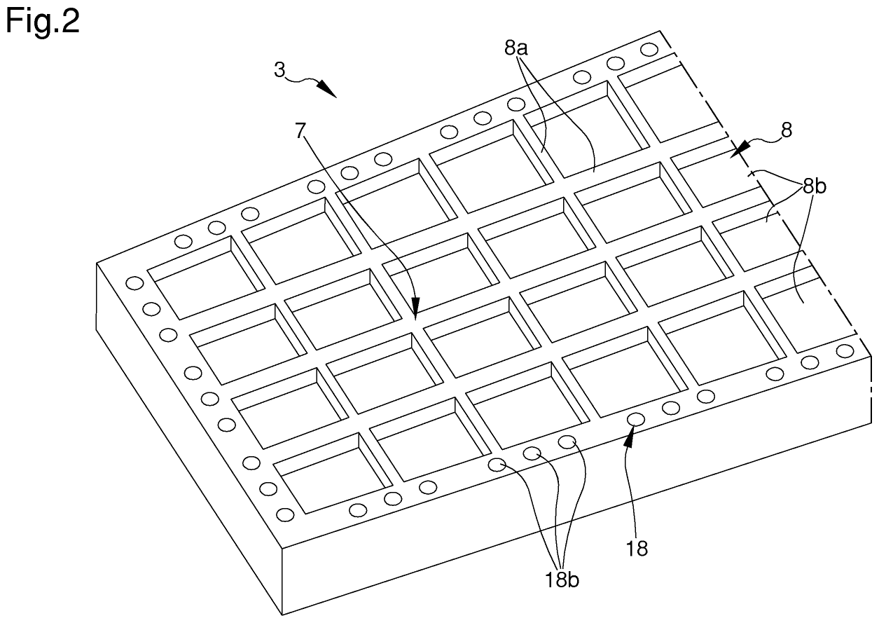

Alternatively, in accordance with a second embodiment shown in FIGS. 2-4, the coffin 1 comprises interlocking means 18, 19, 20 which are associated with each of the boundary walls 2 and are adapted to couple the latter to each other in a modular manner.

Thus, in this case, the coffin 1 turns out to be a modular structure which can be mounted by assembling the boundary walls 2 by means of the interlocking means 18, 19, 20.

The provision of the interlocking means 18, 19, 20 results in numerous advantages mainly related to the simplicity of transportation, storage and handling of the coffin 1.

Indeed, it is easy to appreciate that in this way it is possible to assemble the boundary walls 2 together when needed, for example, when the corpse is laid in the internal volume 5.

In other words, the boundary walls 2 can only be assembled together once the use of the internal volume 5 is actually needed.

In this way, the overall dimensions of the coffin 1 can be greatly reduced, thus simplifying all the phases preceding the assembly of the boundary walls 2.

Going into detail, it is good to specify that the interlocking means 18, 19, 20 comprise first interlocking means 18 between the perimeter walls 4 and the bottom wall 3.

In this case, the first interlocking means 18 comprise a plurality of first interlocking elements 18a, 18b associated with each of the perimeter walls 4 and with the bottom wall 3.

To be precise, the first interlocking means 18 are of the male/female type.

In other words, the first interlocking elements 18a, 18b comprise a plurality of first male elements 18a and a corresponding plurality of first female elements 18b which can be coupled to the first male elements 18a by complementary shape.

This means that the conformation of the first interlocking elements 18a, 18b is such that the first male elements 18a can be fitted to size within the first female elements 18b, by coupling them together.

In this regard, the first interlocking means 18 are selected from the list comprising: bayonet interlocking, round pinning, flat pinning, tenon and mortise, dovetailing, crenellation notching, keying interlocking, butt notching, brick interlocking, ring interlocking, tooth and channel interlocking, tongue and groove interlocking, hook and lugs.

As an example, in the case of first interlocking means 18 of the tenon and mortise type, the first male elements 18a correspond to the tenon and the first female elements 18b correspond to the mortise.

Preferably, the first interlocking elements 18a, 18b are peripherally associated with the upper surface 7 and are associated with each of the lower bases 9.

In this case, the first male elements 18a are associated with each of the lower bases 9 and the first female elements 18b are peripherally associated with the upper surface 7.

This means that the first male elements 18a protrude from the perimeter walls 4 and that the first female elements 18b are cut out internally from the bottom wall 3.

In all cases, the alternative solution cannot be ruled out wherein, in particular, the first male elements 18a are peripherally associated with the upper surface 7 and the first female elements 18b are associated with each of the lower bases 9.

The special positioning of the first interlocking elements 18a, 18b allows the perimeter walls 4 to be easily and intuitively interlocked to the bottom wall 3.

In this way, the assembly of the perimeter walls 4 with the bottom wall 3 can be carried out without requiring the use of specialized personnel for the purpose, thereby lowering the total assembly costs.

By way of an example, in the case of a coffin 1 having a “parallel”/“American-style” shape, it is sufficient to grasp a perimeter wall 4, arrange it perpendicularly to the bottom wall 3 and bring the respective lower base 9 close to the perimeter of the upper surface 7 until the respective first interlocking elements 18a, 18b are interlocked with each other.

By repeating these operations for each perimeter wall 4, it is clearly possible to bound the bottom wall 3, thus defining the internal volume 5 of the coffin 1.

The particular methodology described allows the perimeter walls 4 to be efficiently interlocked with the bottom wall 3.

It may happen, however, that, depending on the size of the perimeter walls 4 and of the bottom wall 3, a thin gap is defined between the latter.

It is straightforward to appreciate, in this regard, that the presence of such a gap would end up undermining the decorum and dignity of the corpse contained in the internal volume 5.

In this sense, the coffin 1 comprises at least one perimeter frame 21 associated with the bottom wall 3 which is adapted to cover at least one gap defined between at least one perimeter wall 4 and the bottom wall 3.

Preferably, the frame 21 has a height of between 3 cm and 7 cm, better still of between 4 cm and 6 cm, preferably equal to 5 cm.

It should be noted that the special sizing of the frame 21 allows the latter to effectively cover the gap defined between at least one perimeter wall 4 and the bottom wall 3, thus preventing, from the outside, the view through it of the internal volume 5.

The interlocking means 18, 19, 20 then comprise second interlocking means 19 between the various perimeter walls 4 comprising second interlocking elements 19a, 19b associated with each of the perimeter walls 4.

To be precise, the second interlocking means 19 are of the male/female type.

In other words, the second interlocking elements 19a, 19b comprise a plurality of second male elements 19a and a corresponding plurality of second female elements 19b that can be coupled to the second male elements 19a by complementary shape.

This means that the conformation of the second interlocking elements 19a, 19b is such that the second male elements 19a can be fitted to size within the second female elements 19b, coupling them together.

As visible in FIG. 3, the second interlocking elements 19a, 19b are substantially shaped as a prism having a T-shaped base.

In actual facts, the second male elements 19a are substantially prism-shaped protrusions having a T-shaped base, and the second female elements 19b are substantially prism-shaped housings having a T-shaped base.

Different conformations of the second interlocking elements 19a, 19b, e.g. parallelepiped, cannot be ruled out in all cases.

Preferably, the second interlocking elements 19a, 19b have a length substantially coincident with the height of the perimeter wall 4 with which they are associated.

In other words, the second interlocking elements 19a, 19b extend along the entire height of the perimeter walls 4.

In addition, each of the second interlocking elements 19a, 19b is associated with at least one of either the internal face 12 or the lateral edge 11 of the perimeter walls 4.

In this regard, it should be highlighted that the particular arrangement of the second interlocking elements 19a, 19b of two perimeter walls 4 to be coupled determines the angle by which these are connected.

Indeed, it is straightforward to appreciate that by arranging the second interlocking elements 19a, 19b of two perimeter walls 4 to be coupled on their respective lateral edges 11, a coupling can be made in which the two perimeter walls 4 are aligned with each other.

Similarly, by arranging the second interlocking element 19 of one of the two perimeter walls 4 to be coupled on the respective lateral edge 11 and by arranging the second interlocking element 19 of the other of the two perimeter walls 4 to be coupled on the respective internal face 12, a coupling can be made wherein the two perimeter walls 4 are inclined to each other to define a right angle.

For example, in the case where the coffin 1 comprises four perimeter walls 4, the second interlocking elements 19a, 19b are associated with the internal faces 12 of two of the perimeter walls 4 and with the lateral edges 11 of the other two perimeter walls 4.

In this way, by mutually coupling the four perimeter walls 4, the bottom wall 3 is bounded to make an internal volume 5 of substantially cubic shape.

It should be noted that the special arrangement of the first interlocking elements 18a, 18b and of the second interlocking elements 19a, 19b allows a perimeter wall 4 to be coupled to another perimeter wall 4 and to the bottom wall 3 in a substantially simultaneous manner.

This evidently allows for a particularly quick and intuitive modular assembly of the coffin 1.

In fact, once a perimeter wall 4 has been interlocked to the bottom wall 3, it is only necessary to grasp another perimeter wall 4, place it side by side with the previous one, and couple the respective second interlocking elements 19a, 19b to connect the two perimeter walls 4 to each other.

Having done so, it is sufficient to repeat the operations listed above for the first interlocking elements 18a, 18b, i.e., bringing the latter perimeter wall 4 close to the upper surface 7, to also couple the first interlocking elements 18a, 18b to each other and connect such perimeter wall 4 to the bottom wall 3 as well.

The particular methodology described allows for the efficient interlocking of the perimeter walls 4 with each other.

It may happen, however, that, depending on the size of the perimeter walls 4, a thin gap is defined between two or more of the latter, which would end up undermining the decorum and dignity of the corpse contained in the internal volume 5.

In this sense, as shown in FIG. 4, the coffin 1 comprises at least one terminal end 22 associated protruding to at least one of the perimeter walls 4 and adapted to cover at least one gap defined between at least two perimeter walls 4.

In accordance with the preferred embodiment, the terminal end 22 has a curved conformation.

Precisely, the terminal end 22 has a substantially C-shaped conformation.

Again, the terminal end 22 has a length substantially coincident with the height of the perimeter walls 4.

In other words, the terminal end 22 extends along the entire height of the perimeter walls 4.

In addition, the terminal end 22 has a radial dimension substantially coincident with the thickness of the perimeter walls 4.

It is therefore easy to appreciate that the terminal end 22 built in accordance with this embodiment allows the gap between two perimeter walls 4 arranged at right angles to be covered due to the overlapping thereof on the gap itself.

In other words, the terminal end 22 is shaped so as to completely circumscribe the lateral thickness of the perimeter wall 4, hiding the gap from view from the outside.

Terminal ends 22 having different conformation and/or size from that just described cannot be ruled out.

For example, terminal ends 22 having a substantially rectilinear conformation cannot be ruled out, thus allowing a gap to be covered which is defined between two perimeter walls 4 side by side.

Advantageously, the interlocking means 18, 19, 20 comprise third interlocking means 20 between the perimeter walls 4 and the lid 6, comprising third interlocking elements 20a, 20b associated with the perimeter walls 4 and with the lid 6.

To be precise, the third interlocking means 20 are of the male/female type.

In other words, the third interlocking elements 20a, 20b comprise a plurality of third male elements 20a and a corresponding plurality of third female elements 20b that can be coupled to the third male elements 20a by complementary shape.

This means that the conformation of the third interlocking elements 20a, 20b is such that the third male elements 20a can be fitted to size within the third female elements 20b, coupling them to each other.

As visible in FIG. 3, the third interlocking elements 20a, 20b are substantially shaped as a prism having a rectangular base.

In actual facts, the third male elements 20a are substantially prism-shaped protrusions having a rectangular base and the third female elements 20b are substantially prism-shaped housings having a rectangular base.

Different conformations of the third interlocking elements 20a, 20b cannot be ruled out in all cases, e.g., spherical third interlocking elements 20a, 20b.

Usefully, the third interlocking elements 20a, 20b are peripherally associated with the lower portion 14 of the lid 6 and are associated with each of the upper bases 10 of the perimeter walls 4.

In the present case, the third male elements 20a are associated with the lower portion 14 and the third female elements 20b are peripherally associated with the upper bases 10.

This means that the third male elements 20a protrude from the lower portion 14 and the third female elements 20b are cut out internally from the upper bases 10.

In all cases, the alternative solution cannot however be ruled out in which, in particular, the third male elements 20a are associated with the upper bases 10 and the first female elements 18b are associated with the lower portion 14.

Once the perimeter walls 4 have been coupled to the bottom wall 3, it is sufficient to arrange the lid 6 to close the internal volume 5 at the top and to arrange the lower portion 14 resting on each of the upper bases 10, to couple the third interlocking elements 20a, 20b to each other.

The third interlocking means 20 allow making, between the perimeter walls 4 and the lid 6, a particularly safe hermetic closure, which ensures efficient isolation of the corpse from the outside.

It has in practice been ascertained that the described invention achieves the intended objects.

In particular, the fact is emphasized that the use of non-biodegradable biopolymers for the construction of the boundary walls makes it possible to obtain an environmentally friendly coffin distinguished by a reduced rate of carbon dioxide production and, therefore, less environmental impact as a result of its combustion.

In addition, the special expedient of providing interlocking means makes it easy and intuitive to couple the boundary walls to each other, thus not requiring the use of specialized personnel for the purpose.

1. Funeral coffin (1) for cremation comprising a plurality of boundary walls (2) made at least partly of a biopolymer material comprising:
at least one bottom wall (3);
a plurality of perimeter walls (4) defining, with said bottom wall (3), at least one internal volume (5) for the containment of at least one corpse;
at least one lid (6) intended to close said internal volume (5) at the top;
characterized by the fact that said biopolymer material is of a non-biodegradable type.

2. Coffin (1) according to claim 1, characterized by the fact that said non-biodegradable biopolymer material is selected from the list comprising: bio-polyethylene, bio-polyethylene furanoate, bio-polyestradiol phosphate, bio-polyethylene terephthalate, bio-polypropylene.

3. Coffin (1) according to claim 1, characterized by the fact that at least one of said boundary walls (2) is made at least partly hollow.

4. Coffin (1) according to claim 1, characterized by the fact that it is made of a single monolithic body.

5. Coffin (1) according to claim 1, characterized by the fact that it comprises interlocking means (18, 19, 20) which are associated with each of said boundary walls (2) and are adapted to couple the latter to each other in a modular manner.

6. Coffin (1) according to claim 5, characterized by the fact that said interlocking means (18, 19, 20) comprise first interlocking means (18) between said perimeter walls (4) and said bottom wall (3) comprising a plurality of first interlocking elements (18a, 18b) associated with each of said perimeter walls (4) and with said bottom wall (3).

7. Coffin (1) according to claim 6, characterized by the fact that:
said bottom wall (3) comprises at least one upper surface (7) facing, in use, said internal volume (5); and that
each of said perimeter walls (4) comprises at least one lower base (9) arranged, in use, resting on said bottom wall (3);
said first interlocking elements (18a, 18b) being peripherally associated with said upper surface (7) and being associated with each of said lower bases (9).

8. Coffin (1) according to claim 1, characterized by the fact that said interlocking means (18, 19, 20) comprise second interlocking means (19) between said perimeter walls (4) comprising second interlocking elements (19a, 19b) associated with each of said perimeter walls (4).

9. Coffin (1) according to claim 8, characterized by the fact that each of said perimeter walls (4) comprises:
at least one internal face (12) facing, in use, said internal volume (5); and
at least one lateral edge (11) arranged transversely with respect to said bottom wall (3) to define, in use, the depth of said internal volume (5);
each of said second interlocking elements (19a, 19b) being associated with at least one of either said internal face (12) or said lateral edge (11).

10. Coffin (1) according to claim 1, characterized by the fact that said interlocking means (18, 19, 20) comprise third interlocking means (20) between said perimeter walls (4) and said lid (6) comprising third interlocking elements (20a, 20b) associated with said perimeter walls (4) and with said lid (6).

11. Coffin (1) according to claim 10, characterized by the fact that:
each of said perimeter walls (4) comprises at least one upper base (10), opposite said lower base (9);
said lid (6) comprises at least one lower portion (14) facing, in use, said internal volume (5) and arranged resting on each of said upper bases (10);
said third interlocking elements (20a, 20b) being peripherally associated with said lower portion (14) and being associated with each of said upper bases (10).
